(19) United States
(12) Patent Application Publication
(10) Pub. No.: US 2024/0156053 A1
(43) Pub. Date: May 16, 2024

(54) A DEVICE FOR DISPENSING MATERIAL CONSUMED BY AN ANIMAL AND MONITORING THE ANIMAL’S CONSUMPTION OF THE MATERIAL, AND RELATED SYSTEMS AND METHODS

(71) Applicant: Dan Munro, Snohomish, WA (US)

(72) Inventor: Dan Munro, Snohomish, WA (US)

(21) Appl. No.: 18/550,269

(22) PCT Filed: Mar. 14, 2022
(86) PCT No.: PCT/US22/71136

§ 371 Date: Sep. 12, 2023

Related U.S. Application Data
(60) Provisional application No. 63/160,363, filed on Mar. 12, 2021.
(60) Provisional application No. 63/160,363, filed on Mar. 12, 2021.

(51) Int. Cl. A01K 5/02; A01K 7/02

(52) U.S. Cl. CPC A01K 5/0283; A01K 7/02

(57) ABSTRACT

A device for dispensing material consumed by an animal and monitoring the animal's consumption of the material, includes a sensor, a valve, and a controller. The sensor is operable to sense an amount of a material that is held in a container and to be consumed by an animal. The valve is operable to control the flow of the material into the container from a source of the material. The controller is coupled with the sensor and with the valve, and operable to direct the valve to open in response to the sensor sensing an amount of material in the container being less than a minimum amount. The controller is also operable to direct the valve to close in response to the sensor sensing an amount of material in the container being above a maximum amount. The maximum amount of material that triggers the controller to direct the valve to close is greater than the minimum amount of material that triggers the controller to direct the valve to open. With the ability to sense the amount of material held in a container, as opposed to sensing that the amount of material held in the container does equal a predetermined amount, the minimum amount of material that triggers the controller to direct the valve to open may be substantially less than the maximum amount of material that triggers the controller to direct the valve to close. This allows one to track remotely an animal's consumption, and based on changes in the consumption, generate and send an alert concerning the animal's health to one not located with animal.

### CROSS-REFERENCE TO RELATED APPLICATIONS AND INCORPORATION BY REFERENCE

This application claims priority from U.S. PCT Patent Application PCT/US22/71136 filed 14 Mar. 2022 and titled “A DEVICE FOR DISPENSING MATERIAL CONSUMED BY AN ANIMAL AND MONITORING THE ANIMAL'S CONSUMPTION OF THE MATERIAL, AND RELATED SYSTEMS AND METHODS”, and from U.S. Provisional Patent Application 63/160,363 filed 12 Mar. 2021 and titled “Cascada Automatic Waterer, and Related Systems and Methods”. This application also incorporates by this reference the entirety of U.S. PCT Patent Application PCT/US22/71136, and the entirety of U.S. Provisional Patent Application 63/160,363.

### BACKGROUND

Proper care for an animal requires that the animal have access to fresh water. This is especially true when caring for horses, cows, and/or sheep. When such animals are corralled or fenced into a field, a common method for providing such access to fresh water is to place a trough in the corral, paddock, and/or fenced-in field, and have water continuously trickle into the trough.

Unfortunately, supplying a continuous trickle of water to the trough often leads to wasting water when the animals don't drink as much as anticipated, or when the valve that regulates the flow of water fails. To overcome this problem, one typically supplies water to the trough when the amount of water in the trough falls below a specific level. If one has to do this himself/herself, then one has to check on the water level at least once a day, and if needed, add more water to the trough. This is especially true when a bucket, typically 5-gallon capacity, hanging from a wall and holding water is used instead of a trough. Horses typically drink about 10 gallons of water a day, therefore one has to check and fill each bucket multiple times a day. This, however, consumes valuable time, especially on a ranch or when caring for many animals, that could otherwise be used for other projects. To free one from this time-consuming chore, many configure an automatic waterer for the trough, that senses when the amount of water in the trough falls below a specific level. When this occurs, the automatic waterer opens a valve on the water supply line to allow water to flow into the trough, similar to the functionality of a float valve in a toilet tank.

Unfortunately, though, such a system has two problems. First, such systems typically operate to keep the amount of water in the trough at a constant level. As soon as the amount of water falls below a specific desired amount, the system opens the supply valve, and as soon as the amount of water reaches the same specific desired amount, the system closes the supply valve. Thus, in operation, the supply valve frequently cycles through opening and closing in response to the amount of water frequently falling below the specific desired amount. This frequent cycling often causes premature damage to the valve.

Second, such systems do not allow a convenient & remote method for monitoring the water consumption of a specific animal. Thus, it's very difficult to gauge the health of a specific animal by monitoring the animal's water and/or food consumption, without manually monitoring the animal's consumption with one's own eyes. Because of this, such monitoring is not frequently done, or done only after an adverse health event, and because of this, many problems with animals that could be easily resolved if discovered quickly, aren't resolved and sometimes turn fatal.

Thus, there is a need for an apparatus that monitors an animal's consumption of material, such as water, food and/or medicine, and efficiently supplies the material automatically when needed.

### SUMMARY

In one aspect of the invention, a device for dispensing material consumed by an animal and monitoring the animal's consumption of the material, includes a sensor, a valve, and a controller. The sensor is operable to sense an amount of a material that is held in a container and to be consumed by an animal. The valve is operable to control the flow of the material into the container from a source of the material. The controller is coupled with the sensor and with the valve, and operable to direct the valve to open in response to the sensor sensing an amount of material in the container being below a minimum amount. When the valve is open material flows through the valve and into the container. The controller is also operable to direct the valve to close in response to the sensor sensing an amount of material in the container being above a maximum amount. When the valve is closed material does not flow through the valve. The maximum amount of material that triggers the controller to direct the valve to close is greater than the minimum amount of material that triggers the controller to direct the valve to open providing hysteresis.

With the ability to sense the amount of material held in a container, as opposed to sensing that the amount of material held in the container has changed, the minimum amount of material that triggers the controller to direct the valve to open (and thus material to flow into the container) may be substantially less than the maximum amount of material that triggers the controller to direct the valve to close (and thus stop the flow of material into the container). This, in turn, reduces the frequency of the on-off cycling of the valve to reduce wear and tear on the valve. In addition, the ability to sense the amount of material held in a container allows one to monitor the consumption of the material over time by one or more animals by frequently sensing the amount of material in the container and recording the specific amount at the specific time of day. This, in turn, allows one to more easily monitor the health of an animal by noticing changes in the animal's consumption of the material before the animal suffers other more advanced symptoms.

In another aspect of the invention, a method for dispensing material consumed by an animal and for monitoring the animal's consumption of the material, includes: 1) sensing an amount of a material that is held in a container and to be consumed by an animal; 2) opening a valve in response to the amount of material sensed in the container being below a minimum amount; 3) allowing material to flow through the valve and into the container when the valve is open; 4) closing the valve in response to the amount of material sensed in the container being above a maximum amount, wherein the maximum amount of material is greater than the minimum amount of material that triggers opening the valve; and 5) stopping the flow of material through the valve into the container when the valve is closed.

### BRIEF DESCRIPTION OF THE DRAWINGS

Each of FIGS. 1A and 1B shows a view of a device for dispensing and monitoring material to be consumed by an animal, according to an embodiment of the invention. FIG. 1A shows a perspective view of the device coupled to a bucket, and FIG. 1B shows a plan view of the device alone.

FIG. 2 shows a side view of the device in FIGS. 1A and 1B, according to an embodiment of the invention.

FIG. 3 shows a rear view of the device in FIGS. 1A and 1B, with components of the device exposed, according to an embodiment of the invention.

### DETAILED DESCRIPTION

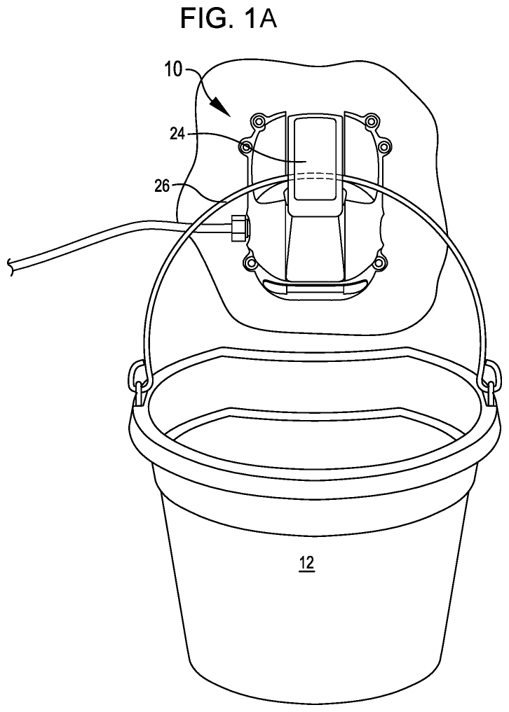

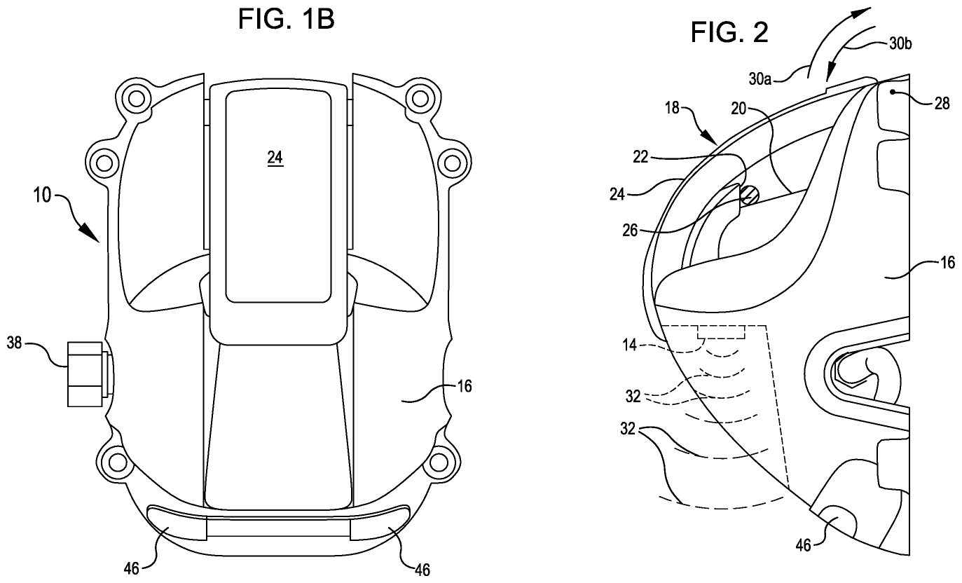

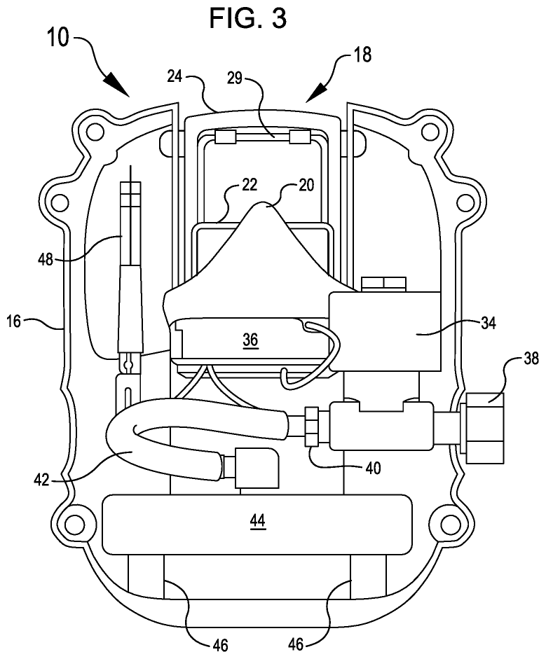

FIG. 1A shows a perspective view of a device 10 coupled to a bucket 12. FIG. 1B shows a plan view of the device 10 without the bucket 12. And FIG. 2 shows a side view of the device 10 without the bucket 12. The device 10 dispenses material, such as water, food and/or medicine into the bucket 12 from which an animal, such as a horse, cow, sheep and/or rabbit, may retrieve and consume the material. The device 10 also controls when material (here water) is dispensed into the bucket 12 to replenish material that has been consumed. In addition, the device 10 monitors how much material is consumed by the animal, and the rate at which the animal consumes the material. To perform these functions, the device 10 includes a sensor 14 (FIG. 2) to sense the amount of a water held in the bucket 12, a valve (shown and discussed in conjunction with FIG. 3) to control the flow of the water into the bucket 12 from a source (not shown), and a controller (also shown and discussed in conjunction with FIG. 3) to direct the valve to open or close in response to the sensor 14 sensing a specific amount of water in the bucket 12. More specifically, when the sensor 14 senses an amount of water in the bucket 12 that is less than or equal to a minimum amount, the controller directs the valve to open to allow water to flow into the bucket 12. And when the sensor 14 senses an amount of water in the bucket 12 that is more than or equal to a maximum amount, the controller directs the valve to close to stop the flow of water into the bucket 12. The maximum amount of water that triggers the controller to direct the valve to close is greater than the minimum amount of material that triggers the controller to direct the valve to open.

The maximum amount of material (here water) and the minimum amount of material that trigger the controller to direct the valve to close and open, respectively, may be any desired amounts. For example, in this and other embodiments the maximum amount of water is double or two times the minimum amount of water. For the bucket 12, whose capacity here is five gallons, the minimum amount of water that triggers the controller to direct the valve to open is two gallons, and the maximum amount of water that triggers the controller to direct the valve to close is four gallons. In other embodiments, the minimum amount of water that triggers the controller to direct the valve to open may be one third of the maximum amount. This ratio may be desirable when the device 10 is used with a trough whose capacity may be fifty gallons, or with a bucket whose capacity maybe seventeen and half gallons and that does not hang from the device 10 but rather lies on the ground beneath the device 10.

With the ability to sense the amount of water held in the bucket 12, as opposed to simply sensing when the amount of water held in the bucket 12 changes, the minimum amount of water that triggers the controller to direct the valve to open may be substantially less than the maximum amount of water that triggers the controller to direct the valve to close. This, in turn, reduces the frequency of the on-off cycling of the valve to reduce wear and tear on the valve. In addition, the ability to sense the amount of water held in the bucket 12 allows one to monitor the consumption of the water over time of one or more animals by frequently sensing the amount of water in the bucket 12 and then recording the specific amount sensed with the specific time of day that the amount was sensed. This, in turn, allows one to more easily monitor the health of an animal by noticing changes in the animal's consumption of water before the animal suffers other more advanced symptoms.

Still referring to FIGS. 1A, 1B, and 2 the device 10 includes a body 16, and a coupler 18 to hold the bucket 12 relative to the body 16 (and thus the sensor 14). The body 16 may be configured as desired. For example, in this and other embodiments, the body 16 is configured to house and protect the device's sensor, valve, and controller (as shown in FIG. 3). More specifically, the body 16 is made of a plastic material to better withstand the conditions of the environment that such a device is likely to be used in. In other embodiments, the body 16 may be made of any desired metal, or any desired combination of plastic and metal.

The coupler 18 may also be configured as desired. For example, in this and other embodiments, the coupler 18 includes a ridge 20, a stop 22, and a lock 24, that together secure the bucket 12 under the device 10. More specifically, the ridge 20 is configured to support the vertical force that the weight of the bucket 12, the weight of the bucket's handle 26, and the weight of the water in the bucket 12 generate. The ridge 20 forms a portion of the body 16 to more easily transfer the load (weight) that the ridge 20 carries to the portion of the device's body 16 that transfers the load to the wall or other structure of the corral or paddock that the device 10 is mounted to. The stop 22 is configured to keep the bucket's handle 26 from sliding off of the ridge 20 (and thus the bucket 12 from falling) when the bucket 12 is jostled by an animal while drinking from the bucket 12. The stop 22, like the ridge 20, also forms a portion of the device's body 16, and is not moveable relative to the ridge 20. Thus, to separate the bucket 12 from the ridge 20 and stop 22, one must lift the handle 26 up and off of the ridge 20, and then up and over the stop 22. The cover 24 is configured to block the bucket's handle 26 from moving off of the ridge 20 and up and over the stop 22. To do this, the lock 24 is pivotally connected to the device's body 16, and pivots about the axis 28 in the directions shown by the arrow 30a and 30b to open and close, respectively, the coupler 18. To urge the cover 24 to the closed position (shown in FIG. 2), a spring 29 (in FIG. 3) is coupled with the cover 24 and the body 14.

Referring to FIG. 2, the sensor 14 may be configured as desired to sense the amount of water held in the bucket 12 at any moment in time. For example, in this and other embodiments, the sensor 14 senses the level of the water in the bucket 12 to determine the amount of water held in the bucket 12. More specifically, the sensor generates a sound wave 32 and directs the wave 32 toward the water in the bucket 12. The sensor 14 then measures the amount of time that it takes for the sound wave to travel to the surface of the water, reflect off the surface, and then travel back to the sensor 14. With the speed of sound through air known, and the time it takes for the sound wave to travel to and from the surface of the water, the sensor 14 and/or controller of the device 10 can calculate the distance of the water's surface from the speed and time information. With this distance information the sensor 14 and/or controller may then determine the amount of water held in the bucket at that moment in time. In other embodiments, the sensor 14 may use a laser, a stereo camera, infrared light, microwaves, or any other type of physical phenomena that allows one to determine the distance of an object from the sensor. In still other embodiments, the sensor 14 may sense the weight of the water in the bucket 12, to determine the amount of water in the bucket 12. In still other embodiments, the sensor 14 may include a camera that captures a visual image of the water in the bucket 12 to allow a person or other circuitry to compare the level with a mark or flag in the bucket that identifies an established known volume. Using a visual image of the material in the bucket 12 may be desirable when the material to be consumed by the animal is medicine or food that is not a liquid.

FIG. 3 shows a rear view of the device 10 in FIGS. 1A, 1B, and 2, with additional components of the device 10 exposed, according to an embodiment of the invention. The additional components of the device 10 include a valve 34 to control the flow of material (here water) into the bucket 12, and a controller 36 to direct the valve 34 to open or close in response to the sensor 14 sensing a specific amount water in the bucket 12.

The valve 34 may be any desired valve capable of controlling the flow of water into the bucket 12. For example, in this and other embodiments the valve 34 includes a solenoid that when energized (electric current flowing through the solenoid's coils) opens the valve to allow water to flow through the valve 34 and into the bucket 12. When the valve's solenoid is not energized (electric current not flowing through the solenoid's coil), the valve 34 is closed to prevent water from flowing through the valve 34. The water that flows through the valve 34 comes from a source (not shown) that is coupled with the valve 34 at the valve's inlet 38, and exits the valve 34 at the valve's outlet 40. After the water flows through the valve's outlet 40, the water flows through a tube 42 into a manifold 44. The water then leaves the manifold 44 through two exits 46 (also shown in FIG. 2). In other embodiments, the valve 34 is configured to allow and prevent the flow of food or other material that is not a liquid. In such embodiments, the opening and closing of the valve 34 may also be performed by energizing and deenergizing a solenoid, but the valve 34 does not have to provide a liquid tight seal when closed.

Still referring to FIG. 3, the controller 36 may be configured as desired to monitor signals that it receives from the sensor 14 and compare each signal to a predetermined signal that identifies an amount of water held in the bucket 12 that triggers operating the valve to open or close. Then, in response to a signal from the sensor 14 that indicates an amount of water in the bucket 12 equal to or less than a minimum amount associated with the predetermined signal, the controller 36 directs a relay (not shown) to allow electric current to flow through the valve's solenoid to open the valve 34. And, in response to a signal from the sensor 14 that indicates an amount of water in the bucket 12 equal to or more than a maximum amount associated with the predetermined signal, the controller 36 directs a relay (not shown) to stop the flow of electric current through the valve's solenoid to close the valve 34. For example, in this and other embodiments, the controller 36 is a conventional proportional-integral-derivative (PID) programmable logic controller (PLC) that uses Ladder Logic as its programming language to process the information (signals) received from the sensor 14.

In other embodiments, the controller 36 may include a computer such as a conventional desktop or laptop computer having a Windows, or OSX operating system, and executing a programmable language other than Ladder Logic. This may be desirable when additional functions of the controller 36 are desired. For example, when multiple device's 10 are combined into a network that one uses to dispense material, control when the material is dispensed, and monitor how much material is consumed by animals in multiple corrals or paddocks, additional processing power that a computer provides may be required. In such a network of devices 10, a central computer can receive signals from each of the sensors 14 in each of the devices 10 and direct the corresponding valve 34 of each device 10 to open and close at the appropriate time. For another example, a computer may be desirable when information regarding the amount and timing of water dispensed by the device 10 is to be stored in a database and then used to track consumption by an animal. The computer may be configured to record such data, calculate an average consumption based on any desired period, such as mornings, afternoons, days, weeks, and/or months, and then compare recently obtained data with the historical average consumption data. The computer may also be configured to then identify changes in the consumption data and alert one to a possible change in the health of the animal reflected by the animal's change in consumption. The computer may also be configured to allow one to access the recorded and calculated data from any location, as well as push significant alerts to one to make sure that a possible detrimental change to an animal's health is quickly addressed.

In this and other embodiments, the controller 36 may also be programmed to direct the valve 34 to perform a procedure to correct or fix the valve 34 when the valve 34 is not operating properly. For example, in this and other embodiments, the controller 36 may be programmed to direct the valve 34 to quickly cycle through opening and closing in response to the sensor 14 sensing a decrease in the distance of the surface of the water in the bucket 12 after the controller 36 directs the valve 34 to close. Such a decrease in the distance could indicate that the valve 34 is stuck open, or is not sealing properly when closed. Quickly opening and closing the valve 34 may free up the drive portion of the valve 34 that could be stuck, or break loose a small piece of material that may be trapped between the portion of the valve 34 that seals together when the valve 34 is closed. Likewise, the controller 36 may be programmed to direct the valve 34 to quickly cycle through closing and opening in response to the sensor 14 sensing an increase or no change in the distance of the water's surface after the controller 36 directs the valve 34 to open. Such an increase or no change in the distance could indicate that the valve 34 is stuck closed. Quickly closing and opening the valve 34 may free up the drive portion of the valve 34 that could be stuck.

Still referring to FIG. 3, in this and other embodiments, the device 10 also includes an antenna 48 coupled with a radio transmitter and receiver to communicate with a computer that is not located with the device 10. As previously mentioned, the computer may provide the controller 36 for multiple devices that are combined into a network. The computer may also simply provide a database that includes information from a sensor 14 and controller 36 of one or more specific devices 10 to facilitate access to the information by one or more users via another computer such as a laptop, a desktop-style computer that remains at a single location, or a smart phone.

Still referring to FIG. 3, the device 10 may also include any other desired component to help the device 10 perform its functions of monitoring how much material is consumed by an animal. For example, in this and other embodiments the device includes a second sensor (not shown) that senses the specific animal consuming material from the bucket 12. More specifically, the second sensor senses the presence of an animal at the bucket 12 and generates a visual image of the animal. This visual image may then be used by the controller 36 to determine the identity of the animal. With this information, the controller 36 may associate other signals generated by the sensor 14, or any other component, while the animal is at the bucket 12 to form a profile for the animal that includes data derived from the signals. This in turn allows a single device 10 to dispense material into a container from which many different animals retrieve and consume the material, and continue to track each animal's consumption of the material.

The preceding discussion is presented to enable a person skilled in the art to make and use the invention. Various modifications to the embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. A device for dispensing material consumed by an animal and for monitoring the animal's consumption of the material, the device comprising:
a sensor operable to sense an amount of a material that is held in a container and to be consumed by an animal;
a valve operable to control the flow of the material into the container from a source of the material; and
a controller coupled with the sensor and with the valve, and operable to direct the valve to:
open in response to the sensor sensing an amount of material in the container being below a minimum amount, wherein when the valve is open material flows through the valve and into the container, and
close in response to the sensor sensing an amount of material in the container being above a maximum amount, wherein the maximum amount of material is greater than the minimum amount of material that triggers the controller to direct the valve to open, and wherein when the valve is closed material does not flow through the valve.

2. The device of claim 1 wherein the material includes at least one of the following: water, food, and medicine.

3. The device of claim 1 wherein the container includes a bucket sized and configured to allow a horse to retrieve material disposed inside the bucket.

4. The device of claim 1 wherein the container includes a bucket sized and configured to allow a rabbit to retrieve material disposed inside the bucket.

5. The device of claim 1 wherein the sensor senses the minimum amount and the maximum amount of material held in the container by sensing the distance that a surface of the material lies from the sensor.

6. The device of claim 1 wherein the sensor senses the minimum amount and the maximum amount of material held in the container by sensing the weight of the material.

7. The device of claim 1 wherein the sensor senses the maximum amount of material held in the container by sensing the duration that the valve is open.

8. The device of claim 1 wherein the sensor senses the minimum amount and the maximum amount of material held in the container by measuring the period that begins with the moment that the sensor directs a sound wave toward a surface of the material lying in the container and that ends with the moment that the sensor senses the echo of the sound wave from the surface of the material.

9. The device of claim 1 wherein the minimum amount of material that triggers the controller to direct the valve to open equals half of the maximum amount of material that triggers the controller to direct the valve to close.

10. The device of claim 1 wherein the controller is operable to direct the valve to:
close in response to the sensor not sensing an increase in the amount of material held in the container while the valve is directed to be open, and
then open soon after being directed to close.

11. The device of claim 1 wherein the controller is operable to direct the valve to:
open in response to the sensor sensing an increase in the amount of material held in the container while the valve is directed to be closed, and
then close soon after being directed to open.

12. The device of claim 1 wherein the controller is operable to record the moment and duration of each opening and each closing of the valve.

13. The device of claim 1 wherein the controller is operable to record the amount of material sensed by the sensor and the moment that the sensor sensed the amount of material.

14. The device of claim 1 wherein the controller is operable to:
determine an amount of material consumed over a period, and
compare the amount of material consumed over the period with an historical average amount of material consumed over a similar period.

15. The device of claim 14 wherein the controller is operable to generate an alert in response to the amount of material consumed over the period being substantially different than the historical average amount consumed over the similar period.

16. The device of claim 1 further comprising another sensor operable to sense the identity of an animal while the animal removes material from the container.

17. The device of claim 1 further comprising a receiver and a transmitter operable to receive and transmit radio waves over a network.

18. The device of claim 1 further comprising a database coupled with the controller and operable to store data about the operation of the device.

19. A method for dispensing material consumed by an animal and for monitoring the animal's consumption of the material, the method comprising:
sensing an amount of a material that is held in a container and to be consumed by an animal;
opening a valve in response to the amount of material sensed in the container being less than or equal to a minimum amount;
allowing material to flow through the valve and into the container when the valve is open;
closing the valve in response to the amount of material sensed in the container being more than or equal to a maximum amount, wherein the maximum amount of material is greater than the minimum amount of material that triggers opening the valve; and
stopping the flow of material through the valve into the container when the valve is closed.

20. The method of claim 19 wherein opening the valve includes a controller directing the valve to open in response to the amount of material sensed in the container being less than a minimum amount.

21. The method of claim 19 wherein closing the valve includes a controller directing the valve to close in response to the amount of material sensed in the container being more than a maximum amount.

22. The method of claim 19 wherein sensing the amount of material in the container includes sensing the distance that a surface of the material lies below a sensor.

23. The method of claim 19 wherein sensing the amount of material in the container includes sensing the weight of the material held in the container.

24. The method of claim 19 wherein sensing the amount of material in the container includes:
a sensor generating a sound wave,
directing the sound wave toward the surface of the material lying below sensor and in the container, and
measuring the period that begins with the moment that the sensor directs the sound wave toward the surface and that ends with the moment that the sensor senses the echo of the sound wave from the surface of the material.

25. The method of claim 19 wherein opening the valve incudes closing the valve in response to the sensor not sensing an increase in the amount of material held in the container while the valve is open, and then, opening the valve soon after closing the valve.

26. The method of claim 19 wherein closing the valve includes opening the valve in response to the sensor sensing an increase in the amount of material held in the container while the valve is closed, and then, closing the valve soon after opening the valve.

27. The method of claim 19 further comprising recording the moment and duration of each opening and each closing of the valve.

28. The method of claim 19 further comprising recording the amount of material sensed by the sensor and the moment that the sensor sensed the amount of material.

29. The method of claim 19 further comprising:
determining an amount of material consumed by an animal over a period, and
comparing the amount of material consumed over the period with an historical average amount of material consumed over a similar period.

30. The method of claim 29 further comprising generating an alert in response to the amount of material consumed over the period being substantially different than the historical average amount of material consumed over a similar period.

31. The method of claim 19 further comprising sensing the identity of an animal while the animal removes material from the container.

32. The method of claim 19 further comprising receiving and sending radio waves over a network to instruct a controller when to open and close the valve, and to obtain data from the controller.

33. The method of claim 19 further comprising accessing a database that stores data about the sensing of the amount of material in the container, the opening of the valve, and the closing of the valve.
